(19) United States
(12) Patent Application Publication
(10) Pub. No.: US 2008/0246999 A1
(43) Pub. Date: Oct. 9, 2008

(54) INK SAVING AND TONE CORRECTION PRINTING TECHNIQUE USING ERROR DIFFUSION

(75) Inventor: Jing-Ming Guo, Taipei County (TW)

Correspondence Address: J C PATENTS, INC., 4 VENTURE, SUITE 250, IRVINE, CA, 92618, US

(73) Assignee: National Taiwan University of Science and Technology, Taipei City (TW)

(21) Appl. No.: 11/836,400

(22) Filed: Aug. 9, 2007

(30) Foreign Application Priority Data
Apr. 4, 2007 (TW) 96111994

(51) Int. Cl. G06K 15/00; G06K 9/00; G06K 9/36

(52) U.S. Cl. 358/3.03; 382/112; 382/238; 382/252

(57) ABSTRACT

An ink saving and tone correction printing technique using error diffusion (EDF) includes receiving a first pixel value v_{i,j} and comparing the first pixel value v_{i,j} with a threshold value to produce a second pixel value b_{i,j} and a reference value p_{i,j}. When the first pixel value v_{i,j} is less than a threshold value, not outputting the second pixel value b_{i,j} and the reference value p_{i,j} is the area of actual non-blank region within a pixel region. When the first pixel value v_{i,j} is greater than the threshold value, outputting the second pixel value b_{i,j} for printing on the pixel region, and the reference value p_{i,j} is the area of actually increased non-blank region within the pixel region and the adjacent pixel regions in which a processing prior to printing has been conducted to decide whether or not to print.

### CROSS-REFERENCE TO RELATED APPLICATION

This application claims the priority benefit of Taiwan application serial no. 96111994, filed on Apr. 4, 2007. All disclosure of the Taiwan application is incorporated herein by reference.

### BACKGROUND OF THE INVENTION

1. Field of the Invention

The present invention generally relates to a printing technique, and more particularly, to a printing technique using error diffusion (EDF) algorithm for ink saving and tone correction.

2. Description of Related Art

The traditional halftone printing technique is based on such an assumption that the ink-dot printed out by a printer is an ideal square dot which has a same size as an ideal pixel square on a paper sheet. Under the assumption, a printed matter with the best image quality is expected when the printer in use gives out evenly dispersed ink-dots, and the above-mentioned halftone printing technique is accordingly termed as dispersed-dot dithering halftone printing technique or blue-noise distribution halftone printing technique.

However in fact, the ink-dot printed by a printer is not an ideal square dot because ink-dots are printed in high speed on a paper sheet and different paper has different ink-absorbing capability. Generally, in the prior art, the ink-dot printed out by a printer is assumed to be an approximate round dot and the round dot is designed to totally contain an ideal pixel square of paper, so that a full-black image is created by printing ink-dots to every ideal pixel square on a piece of paper.

Note that each ink-dot printed by a printer is greater than an ideal pixel square in terms of dot size; therefore, the printed black-white or grayscale image on paper appears to be darker than the corresponding image displayed on screen. Similarly, the printed color image on paper contains tone-offset discrepancy against the corresponding image displayed on screen. Regardless of whether a black-white printing or a color printing, the above-described phenomenon is termed as dot-gain effect.

To soften the dot-gain effect, in the previous method, a so-called clustered-dot dithering halftone printing technique, or termed as green-noise distribution halftone printing technique, was developed, which makes printed ink-dots clustered as close as possible so as to avoid printed ink-dots to be overflowed and spilled on the adjacent ideal pixel squares for softening the black-offset or tone-offset phenomena.

Referring to FIGS. 1A to 2B, FIG. 1A shows the pattern produced by the conventional dispersed-dot dithering halftone printing technique, FIG. 1B shows the pattern produced by the conventional clustered-dot dithering halftone printing technique, FIG. 2A is an image produced by the conventional dispersed-dot dithering halftone printing technique and FIG. 2B is an image produced by the conventional clustered-dot dithering halftone printing technique. Note that the total area overflowed and spilled on the adjacent ideal pixel squares by the ink-dots of FIG. 1A is greater than that of FIG. 1B, therefore, the image of FIG. 2A is certainly darker than the image of FIG. 2B, wherein although the clustered-dot dithering halftone printing technique is helpful to soften the black-offset or tone-offset phenomena, but the image resolution is lowered as a cost.

In order to soften the above-mentioned problems, the prior art further provides an iteration-based halftone printing technique and an error-diffused (EDF) halftone printing technique, wherein the iteration-based halftone printing technique is a very time-consuming operation and thus unfeasible, while the EDF halftone printing technique is able to produce images with higher resolution and reasonable complexity. Therefore, currently available printers usually adopt the EDF halftone printing technique.

FIG. 2C is an image produced by the conventional Floyd-Steinberg EDF printing technique. Compared to FIGS. 2A and 2B, the image in FIG. 2C clearly shows improved black-offset or tone-offset and has higher resolution.

FIG. 3A is a schematic diagram of the conventional Floyd-Steinberg EDF printing technique, wherein x_{i,j} represents input pixel value (or termed as pixel value to be processed presently), v_{i,j} represents gained pixel value (or termed as corrected input grayscale value), b_{i,j} represents actually output binary pixel value (or termed as the result after comparing the pixel value with a threshold value), e_{i,j} represents error value produced by deducting the gained pixel value v_{i,j} from the actually output pixel value b_{i,j} and h_{m,n} represents weight matrix and is the diffusion kernel of EDF printing technique. When b_{i,j} is 1, printer prints an ink-dot on a corresponding ideal pixel square; when b_{i,j} is 0, printer does not print an ink-dot on a corresponding ideal pixel square. h_{m,n} diffuses the errors between a binary result and the gained pixel value v_{i,j} into the adjacent pixel values. Furthermore, the next input pixel value x_{i,j} would be accordingly adjusted to obtain a next gained pixel value v_{i,j}.

FIG. 3B is a schematic diagram of the conventional Pappas-Neuhoff EDF printing technique. An operation module herein calculates a reference value p_{i,j} according to an actually output binary pixel value b_{i,j}, while h_{m,n} diffuses the error between the reference value p_{i,j} and the gained pixel value v_{i,j} into the adjacent pixel values, wherein p_{i,j} is obtained by the following formula:

$${p}_{i , j} = \{ \begin{matrix}{f}_{1} α + {f}_{2} β - {f}_{3} α , & if & {b}_{i , j} = 0 \\ 1 , & if & {b}_{i , j} = 1\end{matrix}$$

Referring to FIGS. 4A and 4B, 5A and 5B, FIGS. 4A and 5A are images produced by the conventional Floyd-Steinberg EDF printing technique and FIGS. 4B and 5B are images produced by the conventional Pappas-Neuhoff EDF printing technique. Compared to the images produced by the conventional Floyd-Steinberg EDF printing technique in FIGS. 4A and 5A, the images produced by the conventional Pappas-Neuhoff EDF printing technique in FIGS. 4B and 5B shows improved black-offset or tone-offset.

Note that the Pappas-Neuhoff EDF printing technique does not completely take into account the area within the processed adjacent ideal pixel squares which the ink-dots are overflowed and spilled with contamination on during printing the ink-dots into the corresponding ideal pixel squares. Therefore, such conventional halftone printing technique does not completely solve the black-offset or tone-offset problem. In addition, the above-mentioned halftone printing technique is based on the assumption that a printed ink-dot completely contains an ideal pixel square. Thus, the printed image still does not get rid of the white-offset, black-offset or tone-offset flaw when the diameter of a printed ink-dot is less than the diagonal length of an ideal pixel case.

### SUMMARY OF THE INVENTION

Accordingly, the present invention is directed to an ink saving and tone correction printing technique using error diffusion so as to reduce the printing cartridge consumption and increase the image resolution of printed matter.

As embodied and broadly described herein, the present invention provides an ink saving and tone correction printing technique using error diffusion (EDF). First, receiving a first pixel value v_{i,j}. Next, comparing the first pixel value v_{i,j} with a threshold value to produce a second pixel value b_{i,j} and a reference value p_{i,j}. Then not outputting the second pixel value b_{i,j} and specifying an area of actual non-blank region within a pixel region as the reference value p_{i,j} when the first pixel value v_{i,j} is less than the threshold value. Or then outputting the second pixel value b_{i,j} for printing on a pixel region and specifying the area of an actually increased non-blank region within the pixel region and a plurality of adjacent pixel regions in which a processing prior to printing has been conducted to decide whether or not to print as the reference value p_{i,j} when the first pixel value v_{i,j} is greater than the threshold value.

In an embodiment of the present invention, the above-mentioned threshold value is 0.5.

In an embodiment of the present invention, when the above-mentioned second pixel value b_{i,j} is greater than the threshold value, an ink-dot is printed to a pixel region.

In an embodiment of the present invention, when the above-mentioned first pixel value v_{i,j} is less than the threshold value and a diameter of the second pixel value b_{i,j} is greater than a diagonal length of the pixel region, the area of actual non-blank region within the pixel region is f₁α+f₂β−f₃γ, wherein
relative positions between the second pixel value b_{i,j} and the adjacent second pixel values b_{nw}, bₙ, bₙₑ and b_{w} are specified by the following equation:

$${w}_{i , j} = [ \begin{matrix}{b}_{nw} & {b}_{n} & {b}_{ne} \\ {b}_{w} & {b}_{i , j} & - \\ - & - & -\end{matrix} ] ,$$

f₁ is the number of ink-dots indicated by the second pixel values bₙ and b_{w},
f₂ is the number of ink-dots indicated by the second pixel values b_{nw} and bₙₑ, wherein when the second pixel value b_{nw} indicates ink-dot printing, both the second pixel values bₙ and b_{w} indicate non printing; and when the second pixel value bₙₑ indicates ink-dot printing, the second pixel values bₙ indicates non printing,
value of f₃ is 1 when both the second pixel values bₙ and b_{w} indicate ink-dot printing, otherwise the value of f₃ is 0,
α represents the area of the ink-dot within the pixel region the second pixel value bₙ corresponding to when the second pixel value b_{i,j} indicates ink-dot printing.
β represents the area of the ink-dot within the pixel region the second pixel value bₙₑ corresponding to when the second pixel value b_{i,j} indicates ink-dot printing, and
γ represents the overlap area of the ink-dots within the pixel region the second pixel value b_{i,j} corresponding to when both the second pixel values bₙ and b_{w} indicate ink-dot printing.

In an embodiment of the present invention, when the above-mentioned first pixel value v_{i,j} is less than the threshold value and a diameter of the second pixel value b_{i,j} is greater than a width of the pixel region but less than a diagonal length of the pixel region, the area of actual non-blank region within the pixel region is f₁δ, wherein
relative positions between the second pixel value b_{i,j} and the adjacent second pixel values b_{nw}, bₙ, bₙₑ and b_{w} are specified by the following equation:

$${w}_{i , j} = [ \begin{matrix}{b}_{nw} & {b}_{n} & {b}_{ne} \\ {b}_{w} & {b}_{i , j} & - \\ - & - & -\end{matrix} ] ,$$

f₁ is the number of ink-dots indicated by the second pixel values bₙ and b_{w}, and
δ represents the area of the ink-dot within the pixel region the second pixel value bₙ corresponding to when the second pixel value b_{i,j} indicates ink-dot printing.

In an embodiment of the present invention, when the above-mentioned first pixel value v_{i,j} is less than the threshold value and a diameter of the second pixel value b_{i,j} is less than a width of the pixel region, the area of actual non-blank region within the pixel region is 0.

In an embodiment of the present invention, when the above-mentioned first pixel value v_{i,j} is greater than the threshold value and a diameter of the second pixel value b_{i,j} is greater than a diagonal length of a pixel region, the area of actually increased non-blank region within the pixel region is 1+f₄α+f₅β−f₆β−f₇γ, wherein
relative positions between the second pixel value b_{i,j} and the adjacent second pixel values b_{nw}, bₙ, bₙₑ and b_{w} are specified by the following equation:

$${w}_{i , j} = [ \begin{matrix}{b}_{nw} & {b}_{n} & {b}_{ne} \\ {b}_{w} & {b}_{i , j} & - \\ - & - & -\end{matrix} ] ,$$

f₄ is the number of the second pixel values bₙ and b_{w} which indicate non printing,
f₅ is the number of the second pixel values b_{nw} and bₙₑ which indicate non printing, wherein when the second pixel value b_{nw} indicates non printing, both the second pixel values bₙ and b_{w} indicate non printing; when the second pixel value bₙₑ indicates non printing, the second pixel value bₙ indicates non printing,
value of f₆ is 1 when the second pixel value bₙ indicates ink-dot printing and both the second pixel values b_{nw} and b_{w} indicate non printing, or the second pixel value b_{w} indicates ink-dot printing and both the second pixel values b_{nw} and bₙ indicate non printing, or the second pixel value bₙ indicates ink-dot printing and the second pixel value bₙₑ indicates non printing, otherwise, value of f₆ is 0,
f₇ is the sum of number of ink-dots indicated by the second pixel values b_{nw} and bₙₑ when the second pixel value bₙ indicates non printing and number of ink-dots indicated by the second pixel value b_{nw} when the second pixel value bₙ indicates non printing,
α represents the area of the ink-dot within the pixel region the second pixel value bₙ corresponding to when the second pixel value b_{i,j} indicates ink-dot printing,
β represents the area of the ink-dot within the pixel region the second pixel value bₙₑ corresponding to when the second pixel value b_{i,j} indicates ink-dot printing, and
γ represents the overlap area of the ink-dots within the pixel region the second pixel value b_{i,j} corresponding to when both the second pixel values bₙ and b_{w} indicate ink-dot printing.

In an embodiment of the present invention, when the above-mentioned first pixel value v_{i,j} is greater than the threshold value and a diameter of the second pixel value b_{i,j} is greater than a width of the pixel region but less than a diagonal length of the pixel region, the area of actually increased non-blank region within the pixel region is ε+f₄δ, wherein
relative positions between the second pixel value b_{i,j} and the adjacent second pixel values b_{nw}, bₙ, bₙₑ and b_{w} are specified by the following equation:

$${w}_{i , j} = [ \begin{matrix}{b}_{nw} & {b}_{n} & {b}_{ne} \\ {b}_{w} & {b}_{i , j} & - \\ - & - & -\end{matrix} ] ,$$

f₄ is the number of the second pixel values bₙ and b_{w} which indicate non printing,
ε represents the area of the ink-dot within the pixel region the second pixel value b_{i,j} corresponding to when the second pixel value b_{i,j} indicates ink-dot printing, and
δ represents the area of the ink-dot within the pixel region the second pixel value bₙ corresponding to when the second pixel value b_{i,j} indicates ink-dot printing.

In an embodiment of the present invention, when the above-mentioned first pixel value v_{i,j} is less than the threshold value and a diameter of the second pixel value b_{i,j} is less than a width of the pixel region, the area of actual non-blank region within the pixel region is πρ²/2, wherein ρ is a ratio of actual round-dot radius over ideal round-dot radius.

In an embodiment of the present invention, after producing the reference value p_{i,j}, further includes deducting the first pixel value v_{i,j} from the reference value p_{i,j} to produce an error value e_{i,j}, and calculating

$${v}_{i , j}^{′} = {x}_{i , j}^{′} - {\sum }_{m , n} {e}_{i + m , j + n} \times {h}_{m , n}$$

to produce another first pixel value v′_{i,j}, wherein x′_{i,j} is an original value of another first pixel value v′_{i,j} and h_{m,n} is a weight matrix.

In the present invention, the ink-dot number of printing is adjustable by further calculating the area of actually increased non-blank region and considering the relation between the ink-dot diameter and the pixel region size, therefore, the present invention not only reduces the printing cartridge consumption, but also softens the black-offsetting or tone-offset flaws and increases the image resolution of printed matter.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A shows the pattern produced by the conventional dispersed-dot dithering halftone printing technique.

FIG. 1B shows the pattern produced by the conventional clustered-dot dithering halftone printing technique.

FIG. 2A is an image produced by the conventional dispersed-dot dithering halftone printing technique.

FIG. 2B is an image produced by the conventional clustered-dot dithering halftone printing technique.

FIG. 2C is an image produced by the conventional Floyd-Steinberg EDF printing technique.

FIG. 3A is a schematic diagram of the conventional Floyd-Steinberg EDF printing technique.

FIG. 3B is a schematic diagram of the conventional Pappas-Neuhoff EDF printing technique.

FIG. 3C is a schematic diagram of the EDF printing technique to an embodiment of the present invention.

FIGS. 4A and 5A are images produced by the conventional Floyd-Steinberg EDF printing technique.

FIGS. 4B and 5B are images produced by the conventional Pappas-Neuhoff EDF printing technique.

FIGS. 4C and 5C are images produced by the EDF printing technique according to the present invention.

FIGS. 6A to 6C are diagrams showing relations between ink-dots and the pixel regions.

FIG. 7 is a statistic chart showing the ink-dot numbers of images produced by printers using three kind of EDF printing technique respectively.

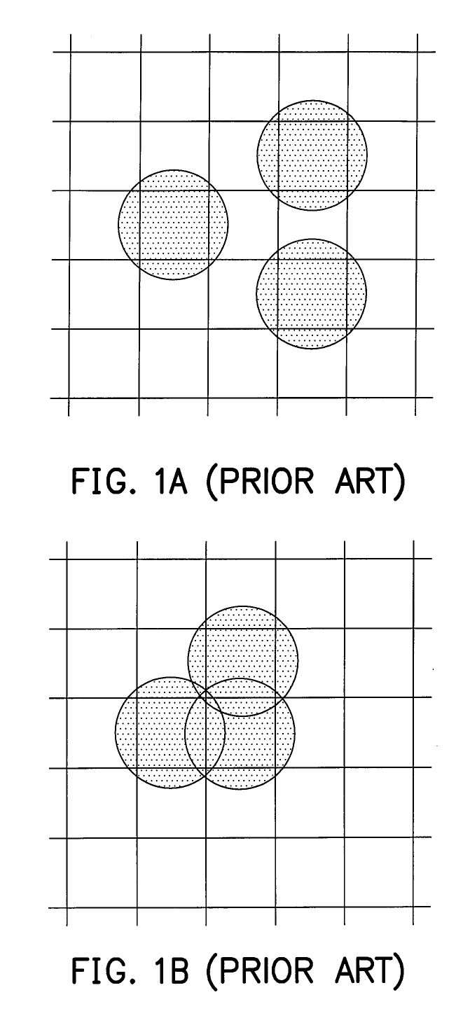

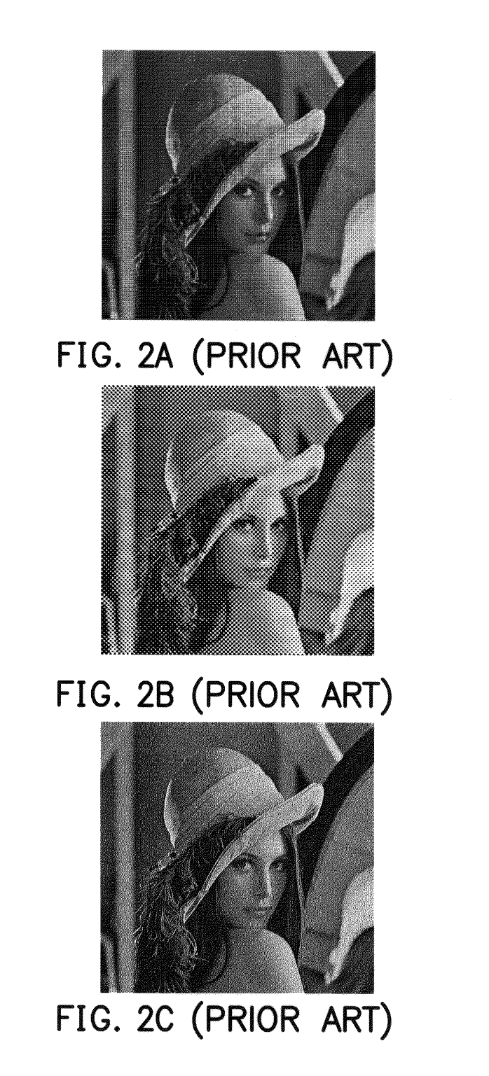

### DESCRIPTION OF THE EMBODIMENTS

Reference will now be made in detail to a present embodiment of the invention, examples of which are illustrated in the accompanying drawings.

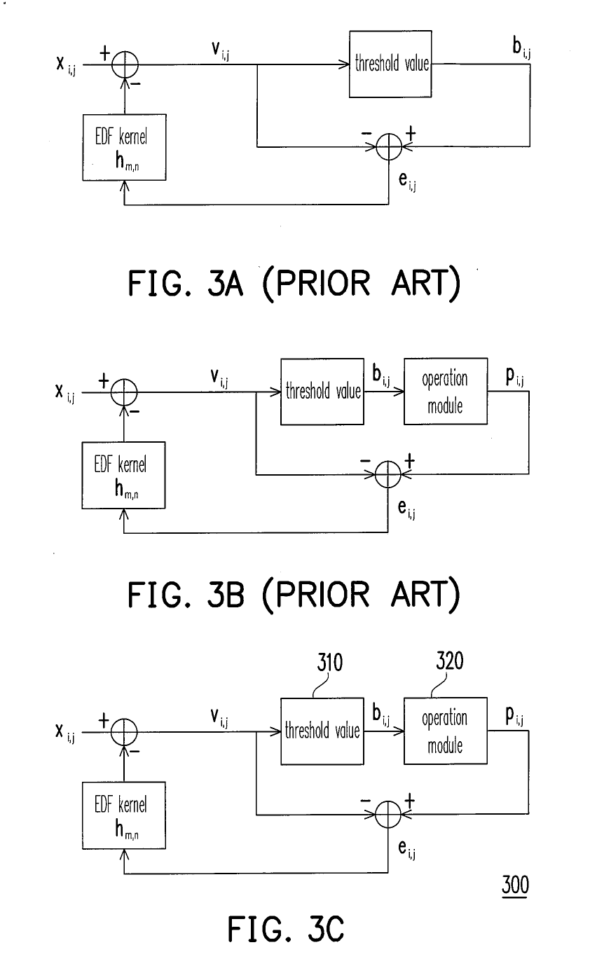

FIG. 3C is a schematic diagram of the EDF printing technique to an embodiment of the present invention. First, the printer module 300 receives a first pixel value v_{i,j}, wherein the first pixel value v_{i,j} can be a pixel value produced by gaining an original pixel value x_{i,j} obtained from a picture. Next, the printer module 300 compares the first pixel value v_{i,j} with a threshold value 310 stored in the printer module 300 to produce a second pixel value b_{i,j}, wherein the second pixel value b_{i,j} can be a binary value and the threshold value 310 is exemplarily, but not limited to, 0.5.

When the first pixel value v_{i,j} is less than the threshold value 310, the second pixel value b_{i,j} is, for example, 0. At this time, the printer module 300 does not output the second pixel value b_{i,j} and does not print on the corresponding pixel region. When the first pixel value v_{i,j} is greater than the threshold value 310, the second pixel value b_{i,j} is, for example, 1. At this time, the printer module 300 outputs the second pixel value b_{i,j} for printing on the corresponding pixel region. Next, an operation module 320 calculates a reference value p_{i,j} according to the second pixel value b_{i,j} (0 or 1) and the reference value p_{i,j} is deducted by the first pixel value v_{i,j} to produce an error value e_{i,j}. Furthermore, a next original pixel value x′_{i,j} is adjusted according to the error value e_{i,j} and then substitutes into the formula of

$${v}_{i , j}^{′} = {x}_{i , j}^{′} - {\sum }_{m , n} {e}_{i + m , j + n} \times {h}_{m , n}$$

to produce a next first pixel value v′_{i,j}, wherein h_{m,n} is a weight matrix.

When the second pixel value b_{i,j} is 0, the reference value p_{i,j} is the area of the actual non-blank region in a corresponding pixel region and is calculated by the following equation:

$${p}_{i , j} = \{ \begin{matrix}{f}_{1} α + {f}_{2} β - {f}_{3} γ , & if & T / \sqrt{2} \leq {r}_{B} & ( 1 ) \\ {f}_{1} δ , & if & T / 2 \leq {r}_{B} \leq T / \sqrt{2} & ( 2 ) \\ 0 , & if & {r}_{B} < T / 2 & ( 3 )\end{matrix}$$

When the second pixel value b_{i,j} is 1, the reference value p_{i,j} is the area of the actually increased non-blank region within the corresponding pixel region and a plurality of adjacent pixel regions in which a processing prior to printing has been conducted to decide whether or not to print, and the reference value p_{i,j} is calculated by the following equation:

$${p}_{i , j} = \{ \begin{matrix}1 + {f}_{4} α + {f}_{5} β - {f}_{6} β - {f}_{7} γ , & if & T / \sqrt{2} \leq {r}_{B} & ( 4 ) \\ ɛ + {f}_{4} δ , & if & T / 2 \leq {r}_{B} \leq T / \sqrt{2} & ( 5 ) \\ π {ρ}^{2} / 2 , & if & {r}_{B} < T / 2 & ( 6 )\end{matrix}$$

The adjacent pixel regions in which a processing prior to printing has been conducted to decide whether or not to print are, for example, the pixel regions respectively located at the upper-left position, the upper position, the upper right position and the left position of the pixel region. Moreover for simplicity, when the second pixel value b_{i,j} is 0, the corresponding pixel region can be seen as a white-dot, and when the second pixel value b_{i,j} is 1, the corresponding pixel region can be seen as an ink-dot. T represents a width of pixel region, r_{B} represents an ink-dot radius, ρ is a ratio of actual round-dot radius over ideal round-dot radius, α, β, γ, δ and ε respectively represent an area, and f₁, f₂, f₃, f₄, f₅, f₆ and f₇ respectively represent a number.

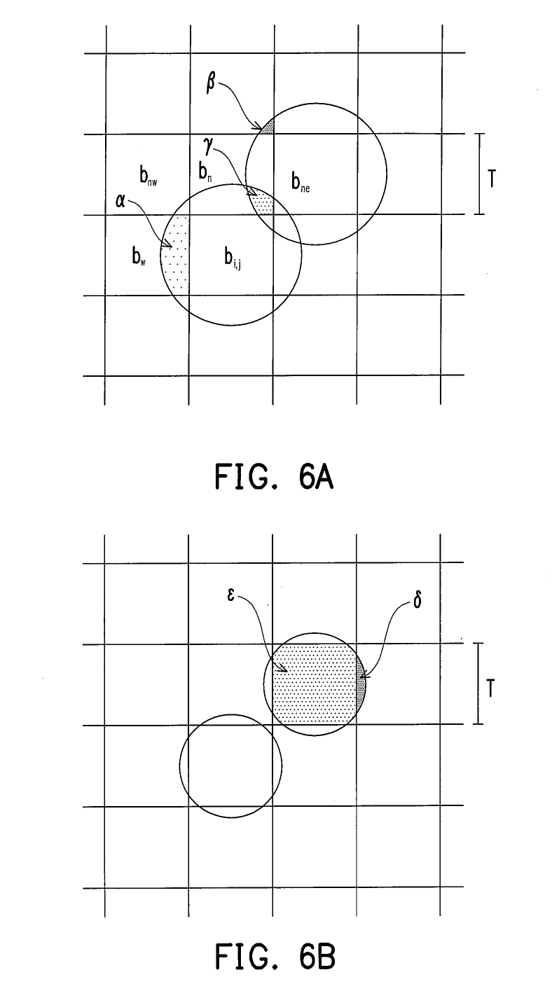

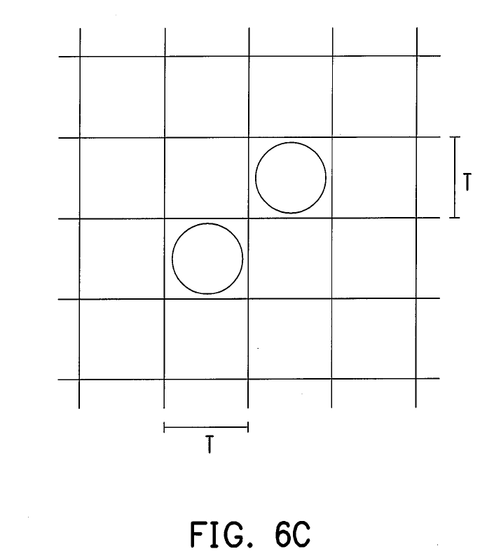

FIGS. 6A to 6C are diagrams showing relations between ink-dots and the pixel regions, wherein the ink-dot diameter in FIG. 6A is greater than the diagonal length of a pixel region, the ink-dot diameter in FIG. 6B is greater than a width of a pixel region and less than the diagonal length of a pixel region and the ink-dot diameter in FIG. 6C is less than the width of a pixel region. It is assumed that the relative positions between the second pixel value b_{i,j} and the adjacent second pixel values b_{nw}, bₙ, bₙₑ and b_{w} are specified by the following equation:

$${w}_{i , j} = [ \begin{matrix}{b}_{nw} & {b}_{n} & {b}_{ne} \\ {b}_{w} & {b}_{i , j} & - \\ - & - & -\end{matrix} ] .$$

It can be obtained from the above-mentioned figures that:
α represents the area of the ink-dot within the pixel region the second pixel value bₙ corresponding to when the second pixel value b_{i,j} indicates ink-dot printing and can be obtained by the following equation:

$$α = \frac{1}{4} \sqrt{2 {ρ}^{2} - 1} + \frac{{ρ}^{2}}{2} {sin}^{- 1} ( \frac{1}{\sqrt{2 } ρ} ) - \frac{1}{2} ,$$

β represents the area of the ink-dot within the pixel region the second pixel value bₙₑ corresponding to when the second pixel value b_{i,j} indicates ink-dot printing and can be obtained by the following equation:

$$β = \frac{π {ρ}^{2}}{8} - \frac{{ρ}^{2}}{2} {sin}^{- 1} ( \frac{1}{\sqrt{2 } ρ} ) - \frac{1}{4} \sqrt{2 {ρ}^{2} - 1} + \frac{1}{4} ,$$

γ represents the overlap area of the ink-dots within the pixel region the second pixel value b_{i,j} corresponding to when both the second pixel values bₙ and b_{w} indicates ink-dot printing and can be obtained by the following equation:

$$γ = \frac{{ρ}^{2}}{2} {sin}^{- 1} ( \sqrt{\frac{{ρ}^{2} - 1}{{ρ}^{2}}} ) - \frac{1}{2} \sqrt{{ρ}^{2} - 1} - β ,$$

δ represents the area of the ink-dot within the pixel region the second pixel value bₙ corresponding to when the second pixel value b_{i,j} indicates ink-dot printing and can be obtained by the following equation:

$$δ = \frac{{ρ}^{2}}{2} {cos}^{- 1} ( \frac{1}{\sqrt{2 } ρ} ) - \frac{1}{4} \sqrt{2 {ρ}^{2} - 1} ,$$

ε represents the area of the ink-dot within the pixel region the second pixel value b_{i,j} corresponding to when the second pixel value b_{i,j} indicates ink-dot printing can be obtained by the following equation:

$$ɛ = \frac{π {ρ}^{2}}{2} - 4 δ ,$$

f₁ is the number of the ink-dots indicated by the second pixel values bₙ and b_{w},
f₂ is the number of the ink-dots indicated by the second pixel values b_{nw} and bₙₑ wherein when the second pixel value b_{nw} indicates ink-dot printing, both the second pixel values bₙ and b_{w} indicate non printing; and when the second pixel value bₙₑ indicates ink-dot printing, the second pixel values bₙ indicates non printing,
value of f₃ is 1 when both the second pixel values bₙ and b_{w} indicate ink-dot printing, otherwise the value of f₃ is 0,
f₄ is the number of the second pixel values bₙ and b_{w} which indicate non printing,
f₅ is the number of the second pixel values b_{nw} and bₙₑ which indicate non printing, wherein when the second pixel value b_{nw} indicates non printing, both the second pixel values bₙ and b_{w} indicate non printing; when the second pixel value bₙₑ indicates non printing, the second pixel value bₙ indicates non printing,
value of f₆ is 1 when the second pixel value bₙ indicates ink-dot printing and both the second pixel values b_{nw} and b_{w} indicate non printing, or the second pixel value b_{w} indicates ink-dot printing and both the second pixel values b_{nw} and bₙ indicate non printing, or the second pixel value bₙ indicates ink-dot printing and the second pixel value bₙₑ indicates non printing, otherwise, value of f₆ is 0, and
f₇ is the sum of number of ink-dots indicated by the second pixel values b_{nw} and bₙₑ when the second pixel value bₙ indicates non printing and number of ink-dots indicated by the second pixel value bₙ when the second pixel value b_{w} indicates non printing,

Referring to FIG. 6A, for example, b_{i,j} and bₙₑ indicate a ink-dots, bₙ and b_{nw}, bₙ and b_{w} indicate a white-dot, and the ink-dot diameter in FIG. 6A is greater than the diagonal length of the pixel region. Thus, the above-mentioned formula (4) may be used to calculate p_{i,j}, wherein f₄ is equal to 2, f₅ is equal to 1, f₆ is equal to 0 and f₇ is equal to 1, and the area of actually increased non-blank region p_{i,j} is 1+2α+β−γ.

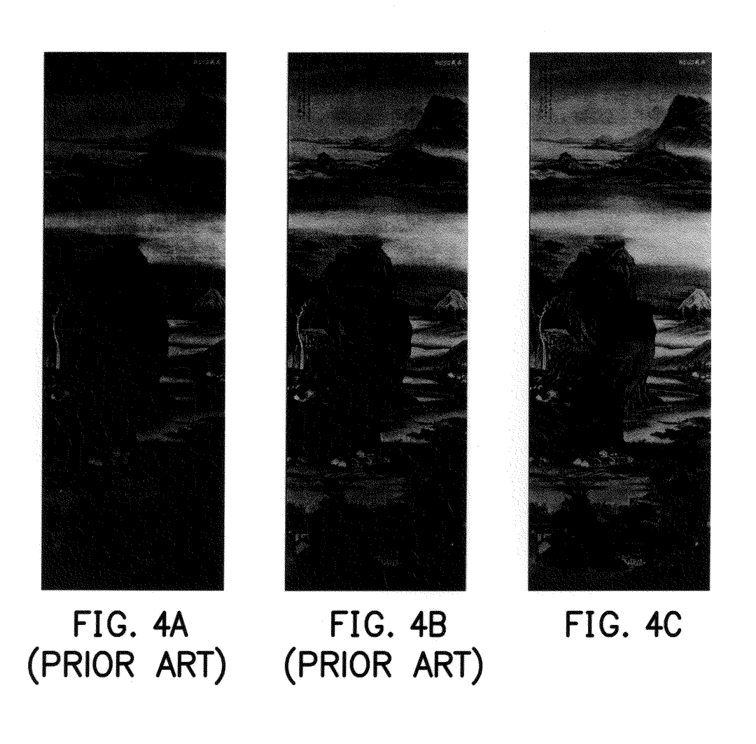

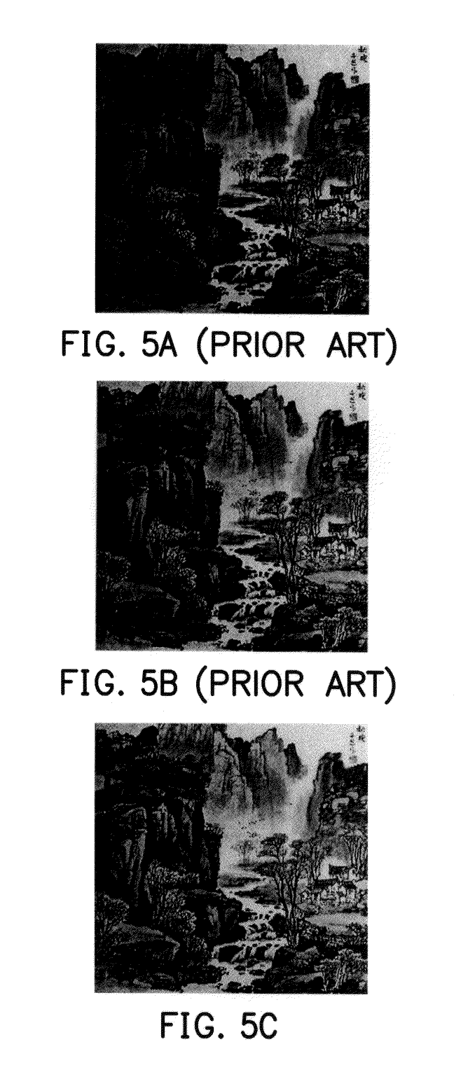

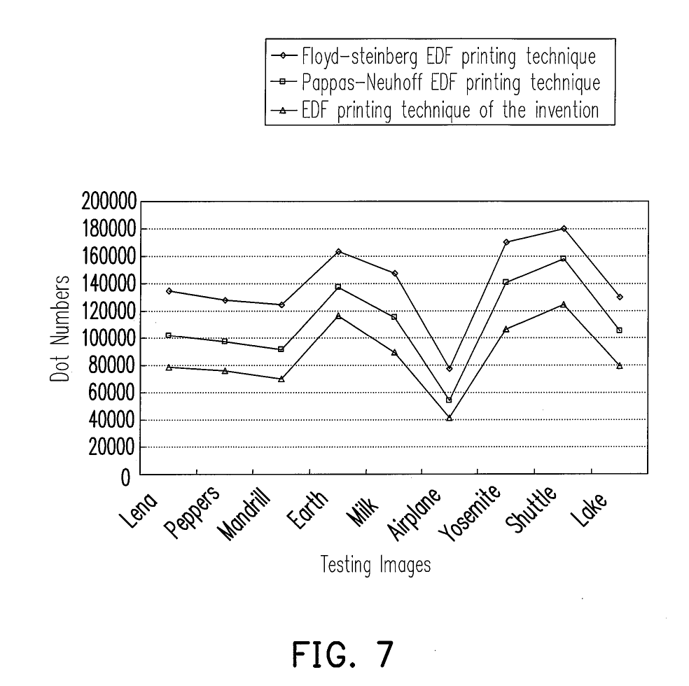

FIGS. 4C and 5C are images produced by the EDF printing technique according to the present invention, while FIG. 7 is a statistic chart showing the ink-dot numbers of images produced by printers using three kind of EDF printing technique respectively. Compared to the images produced by Floyd-Steinberg EDF printing technique and Pappas-Neuhoff EDF printing technique, it can be seen from FIGS. 4A to 5C that the images produced by the EDF printing technique of the present invention can effectively solve tone-offset flaws. Moreover from FIG. 7, it can be seen that the present invention can also effectively reduce the printing cartridge consumption (carbon toner cartridge or ink cartridge).

In addition, the present invention can be applied to a built-in operation chip in a printer, so that the printer works by means of the calculations of the operation chip to solve tone-offset flaws of printed matter. Moreover, the present invention can be applied to a driver, so that a printer works by means of the calculations through a computer installed the driver to solve tone-offset flaws of printed matter.

In summary, since the present invention is able to adjust the ink-dot number of printing by calculating the area of actually increased non-blank regions and considering the relation between the ink-dot diameter and the pixel region size, therefore, the present invention not only reduces the printing cartridge consumption, but also softens the black-offsetting or tone-offset flaws of and increases the image resolution of printed matter.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An ink saving and tone correction printing technique using error diffusion comprising:
receiving a first pixel value v_{i,j};
comparing the first pixel value v_{i,j} with a threshold value to produce a second pixel value b_{i,j} and a reference value p_{i,j};
not outputting the second pixel value b_{i,j} and specifying an area of actual non-blank region within a pixel region as the reference value p_{i,j} when the first pixel value v_{i,j} is less than the threshold value; and
outputting the second pixel value b_{i,j} for printing on a pixel region and specifying the area of an actually increased non-blank region within the pixel region and a plurality of adjacent pixel regions in which a processing prior to printing has been conducted to decide whether or not to print as the reference value p_{i,j} when the first pixel value v_{i,j} is greater than the threshold value.

2. The ink saving and tone correction printing technique using error diffusion according to claim 1, wherein the threshold value is 0.5.

3. The ink saving and tone correction printing technique using error diffusion according to claim 1, wherein when the second pixel value b_{i,j} is greater than the threshold value, an ink-dot is printed to a pixel region.

4. The ink saving and tone correction printing technique using error diffusion according to claim 3, wherein when the first pixel value v_{i,j} is less than the threshold value and a diameter of the second pixel value b_{i,j} is greater than a diagonal length of the pixel region, the area of actual non-blank region within the pixel region is f₁α+f₂β−f₃γ, wherein
relative positions between the second pixel value b_{i,j} and the adjacent second pixel values b_{nw}, bₙ, bₙₑ and b_{w} are specified by the following equation:
$${w}_{i , j} = [ \begin{matrix}{b}_{nw} & {b}_{n} & {b}_{ne} \\ {b}_{w} & {b}_{i , j} & - \\ - & - & -\end{matrix} ] ,$$
f₁ is the number of ink-dots indicated by the second pixel values bₙ and b_{w},
f₂ is the number of ink-dots indicated by the second pixel values b_{nw} and bₙₑ, wherein when the second pixel value b_{nw} indicates ink-dot printing, both the second pixel values bₙ and b_{w} indicate non printing; when the second pixel value bₙₑ indicates ink-dot printing, the second pixel values bₙ indicates non printing,
value of f₃ is 1 when both the second pixel values bₙ and b_{w} indicate ink-dot printing, otherwise value of f₃ is 0,
α represents the area of the ink-dot within the pixel region the second pixel value bₙ corresponding to when the second pixel value b_{i,j} indicates ink-dot printing,
β represents the area of the ink-dot within the pixel region the second pixel value bₙₑ corresponding to when the second pixel value b_{i,j} indicates ink-dot printing, and
γ represents the overlap area of the ink-dots within the pixel region the second pixel value b_{i,j} corresponding to when both the second pixel values bₙ and b_{w} indicate ink-dot printing.

5. The ink saving and tone correction printing technique using error diffusion according to claim 3, wherein when the first pixel value v_{i,j} is less than the threshold value and a diameter of the second pixel value b_{i,j} is greater than a width of the pixel region but less than a diagonal length of the pixel region, the area of actual non-blank region within the pixel region is f₁δ, wherein
relative positions between the second pixel value b_{i,j} and the adjacent second pixel values b_{nw}, bₙ, bₙₑ and b_{w} are specified by the following equation:
$${w}_{i , j} = [ \begin{matrix}{b}_{nw} & {b}_{n} & {b}_{ne} \\ {b}_{w} & {b}_{i , j} & - \\ - & - & -\end{matrix} ] ,$$
f₁ is the number of ink-dots indicated by the second pixel values bₙ and b_{w}, and
δ represents the area of the ink-dot within the pixel region the second pixel value bₙ corresponding to when the second pixel value b_{i,j} indicates ink-dot printing.

6. The ink saving and tone correction printing technique using error diffusion according to claim 3, wherein when the first pixel value v_{i,j} is less than the threshold value and a diameter of the second pixel value b_{i,j} is less than a width of the pixel region, the area of actual non-blank region within the pixel region is 0.

7. The ink saving and tone correction printing technique using error diffusion according to claim 3, wherein when the first pixel value v_{i,j} is greater than the threshold value and a diameter of the second pixel value b_{i,j} is greater than a diagonal length of the pixel region, the area of actually increased non-blank region within the pixel region is 1+f₄α+f₅β−f₆β−f₇γ, wherein
relative positions between the second pixel value b_{i,j} and the adjacent second pixel values b_{nw}, bₙ, bₙₑ and b_{w} are specified by the following equation:
$${w}_{i , j} = [ \begin{matrix}{b}_{nw} & {b}_{n} & {b}_{ne} \\ {b}_{w} & {b}_{i , j} & - \\ - & - & -\end{matrix} ] ,$$
f₄ is the number of the second pixel values bₙ and b_{w} which indicate non printing,
f₅ is the number of the second pixel values b_{nw} and bₙₑ which indicate non printing, wherein when the second pixel value b_{nw} indicates non printing, both the second pixel values bₙ and b_{w} indicate non printing; when the second pixel value bₙₑ indicates non printing, the second pixel value bₙ indicates non printing,
value of f₆ is 1 when the second pixel value bₙ indicates ink-dot printing and both the second pixel values b_{nw} and bₙ indicate non printing, or the second pixel value b_{w} indicates ink-dot printing and both the second pixel values b_{nw} and bₙ indicate non printing, or the second pixel value bₙ indicates ink-dot printing and the second pixel value bₙₑ indicates non printing, otherwise value of f₆ is 0.
f₇ is the sum of number of ink-dots indicated by the second pixel values b_{nw} and bₙₑ when the second pixel value bₙ indicates non printing and number of ink-dots indicated by the second pixel value b_{nw} when the second pixel value bₙ indicates non printing,
α represents the area of the ink-dot within the pixel region the second pixel value bₙ corresponding to when the second pixel value b_{i,j} indicates ink-dot printing,
β represents the area of the ink-dot within the pixel region the second pixel value bₙₑ corresponding to when the second pixel value b_{i,j} indicates ink-dot printing, and
γ represents the overlap area of the ink-dots within the pixel region the second pixel value b_{i,j} corresponding to when both the second pixel values bₙ and b_{w} indicate ink-dot printing.

8. The ink saving and tone correction printing technique using error diffusion according to claim 3, wherein when the first pixel value v_{i,j} is greater than the threshold value and a diameter of the second pixel value b_{i,j} is greater than a width of the pixel region but less than a diagonal length of the pixel region, the area of actually increased non-blank region within the pixel region is ε+f₄δ, wherein relative positions between the second pixel value b_{i,j} and adjacent second pixel values b_{nw}, bₙ, bₙₑ and b_{w} are specified by the following equation:
$${w}_{i , j} = [ \begin{matrix}{b}_{nw} & {b}_{n} & {b}_{ne} \\ {b}_{w} & {b}_{i , j} & - \\ - & - & -\end{matrix} ] ,$$
f₄ is the number of the second pixel values bₙ and b_{w} which indicate non printing,
ε represents the area of the ink-dot within the pixel region the second pixel value b_{i,j} corresponding to when the second pixel value b_{i,j} indicates ink-dot printing, and
δ represents the area of the ink-dot within the pixel region the second pixel value bₙ corresponding to when the second pixel value b_{i,j} indicates ink-dot printing.

9. The ink saving and tone correction printing technique using error diffusion according to claim 3, wherein when the first pixel value v_{i,j} is less than the threshold value and a diameter of the second pixel value b_{i,j} is less than a width of the pixel region, the area of actual non-blank region within the pixel region is πρ²/2, wherein ρ is a ratio of actual round-dot radius over ideal round-dot radius.

10. The ink saving and tone correction printing technique using error diffusion according to claim 1, wherein after producing the reference value p_{i,j}, further comprising:
deducting the first pixel value v_{i,j} from the reference value p_{i,j} to produce an error value e_{i,j}; and
calculating
$${v}_{i , j}^{′} = {x}_{i , j}^{′} - {\sum }_{m , n} {e}_{i + m , j + n} \times {h}_{m , n}$$
to produce another first pixel value v′_{i,j}, wherein x′_{i,j} is an original value of another first pixel value v′_{i,j} and h_{m,n} is a weight matrix.
